(19) United States
(12) Patent Application Publication
(10) Pub. No.: US 2012/0243932 A1
(43) Pub. Date: Sep. 27, 2012

(54) QUICK RELEASE VEHICLE ACCESSORY CONNECTION SYSTEM

(75) Inventor: Robert F. McCann, Newport Coast, CA (US)

(73) Assignee: GM GLOBAL TECHNOLOGY OPERATIONS LLC, Detroit, MI (US)

(21) Appl. No.: 13/069,451

(22) Filed: Mar. 23, 2011

(51) Int. Cl. F16B 35/06; F16B 17/00

(52) U.S. Cl. 403/287

(57) ABSTRACT

An accessory connection system for a vehicle includes a male connector portion that is attached to a vehicle accessory, and a female connector portion that is attached to the vehicle through a threaded engagement with a body of the vehicle. The accessory is attached to the vehicle by slideably inserting the male connector portion into a central opening of the female connector, whereby a locking mechanism secures the male connector portion axially in place. The central opening defines a non-circular cross sectional shape, with the male connector portion having a base that compliments the non-circular cross sectional shape to fit therein and prevent rotation of the male connector portion relative to the female connector. The accessory is removed by moving the locking mechanism to a release position, and withdrawing the male connector portion from the female connector.

### TECHNICAL FIELD

The invention generally relates to an accessory connection system for a vehicle.

### BACKGROUND

Vehicles may include accessories that must be attached to a body of the vehicle. The accessories may include, but are not limited to, cargo area tie-downs, storage units, electronic devices such as GPS navigators and/or radar detectors, clothes hangers, hooks, etc. The different accessories are currently attached to the body with several different methods, such as with two sided tape, screws, adhesives, etc.

### SUMMARY

A vehicle is provided. The vehicle includes a body that defines a threaded aperture. A female connector is in threaded engagement with the threaded aperture. The female connector defines a central opening that extends along a longitudinal axis. The female connector includes a locking mechanism that is moveable between a locking position and a release position. An accessory having a male connector portion is slideably insertable into the central opening of the female connector. The locking mechanism axially secures the male connector portion to prevent movement along the longitudinal axis when in the locking position. The locking mechanism releases the male connector portion to allow axial movement along the longitudinal axis when in the release position. The central opening defines a non-circular cross sectional shape perpendicular to the longitudinal axis. The male connector portion includes a base that defines a shape complimentary to the non-circular cross sectional shape of the central opening for mating with the central opening such that the base is rotationally fixed relative to the female connector when disposed within the central opening.

An accessory connection system for a vehicle is also provided. The accessory connection system includes a female connector that is configured for threaded engagement with a threaded aperture in a vehicle. The female connector defines a central opening that extends along a longitudinal axis. The female connector includes a locking mechanism that is moveable between a locking position and a release position. A male connector portion is configured for attachment to an accessory. The male connector portion is slideably insertable into the central opening of the female connector. The locking mechanism axially secures the male connector portion to prevent movement along the longitudinal axis when in the locking position, and releases the male connector portion to allow axial movement along the longitudinal axis when in the release position.

An accessory connection system for a vehicle is also provided. The accessory connection system includes a female connector that is configured for threaded engagement with a threaded aperture in a vehicle. The female connector includes a tubular portion that defines a central opening. The central opening extends along a longitudinal axis. The tubular portion further includes a plurality of bores that extend radially through the tubular portion into the central opening. The plurality of bores is disposed radially about the longitudinal axis. The female connector further includes a threaded portion that extends from the tubular portion and defines threads, and a locking mechanism that is moveable between a locking position and a release position. The locking mechanism includes a sleeve that is disposed annularly about an outer periphery of the tubular portion. The sleeve is moveable relative to the tubular portion along the longitudinal axis between the locking position and the release position. A biasing device is disposed between the sleeve and the tubular portion to bias the sleeve axially along the longitudinal axis into the locking position. The sleeve compresses the biasing device when in the release position. The locking mechanism further includes a plurality of locking balls. One of the locking balls is disposed within each of the plurality of bores. Movement of the sleeve from the locking position into the release position allows the locking balls to move radially outward away from the longitudinal axis and out of interlocking engagement with the male connector portion. Movement of the sleeve from the release position into the locking position moves the locking balls radially inward toward the longitudinal axis into interlocking engagement with the male connector portion. A male connector portion is configured for attachment to an accessory. The male connector portion includes a base and a shaft extending outward away from the base to a distal end. The shaft defines a ridge that extends radially outward from the shaft. The shaft is slideably insertable into the central opening of the female connector such that, when fully inserted into the female connector, the ridge is disposed axially along the longitudinal axis beyond the plurality of locking balls, between the plurality of locking balls and a bottom wall of the central opening. The locking balls are restrained from radial movement outward away from the shaft of the male connector portion by the sleeve when the sleeve is in the locking position to secure the male connector portion relative to the female connector. The locking balls are allowed to move radially outward away from the shaft of the male connector portion when the sleeve is in the release position to allow axial movement of the shaft along the longitudinal axis relative to the female connector. The central opening defines a non-circular cross sectional shape perpendicular to the longitudinal axis. The base of the male connector portion defines a shape complimentary to the non-circular cross sectional shape of the central opening for mating with the central opening such that the base is rotationally fixed relative to the female connector when disposed within the central opening. Both the shaft of the male connector portion and the threaded portion of the female connector define solid cross sectional areas.

Accordingly, the accessory connection system allows for quick and easy attachment and detachment of various accessories to the body of the vehicle. Any accessory having the male connector portion attached thereto may be quickly connected to the vehicle by inserting the male connector portion into the central opening of the female connector. The locking mechanism restrains the accessory axially along the longitudinal axis, and the complimentary shape between the base of the male connector portion and the central opening restrain the accessory from rotation relative to the female connector. The accessory is easily removed by sliding the sleeve into the release position, and withdrawing the male connector portion from the central opening. Multiple threaded apertures may be positioned within the vehicle to allow for multiple and/or different attachment points for the accessories.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a cargo area of a vehicle showing an accessory connection system.

FIG. 2 is a schematic cross sectional view of the accessory connection system showing a locking mechanism in a locked position.

FIG. 3 is a schematic cross sectional view of the accessory connection system showing the locking mechanism in a release position.

### DETAILED DESCRIPTION

Referring to the Figures, wherein like numerals indicate like parts throughout the several views, a vehicle is shown schematically at 20. The vehicle 20 may include any type and/or style of vehicle 20. The vehicle 20 includes an accessory connection system 22. The accessory connection system 22 is shown in a cargo area of the vehicle 20, such as a trunk of a passenger car or a bed of a truck. However, it should be appreciated that the accessory connection system 22 may be located anywhere on the vehicle 20, including but not limited to the cargo area shown, an interior passenger compartment of the vehicle 20, an engine compartment of the vehicle 20, or on an exterior surface of the vehicle 20. Furthermore, while only a single accessory 24 connection location is shown, it should be appreciated that the vehicle 20 may include multiple accessory 24 connection locations throughout the vehicle 20.

The accessory connection system 22 quickly connects and disconnects an accessory 24 to and from the vehicle 20. The accessory 24 may include but is not limited to one of a tie down, a storage unit, a mounting structure, an electronic device, a clothes hook, or a grab bar. The accessories 24 may be connected to the vehicle 20 through only a single connection location, or may alternatively require multiple connection locations to securely connect the accessory 24 to the vehicle 20.

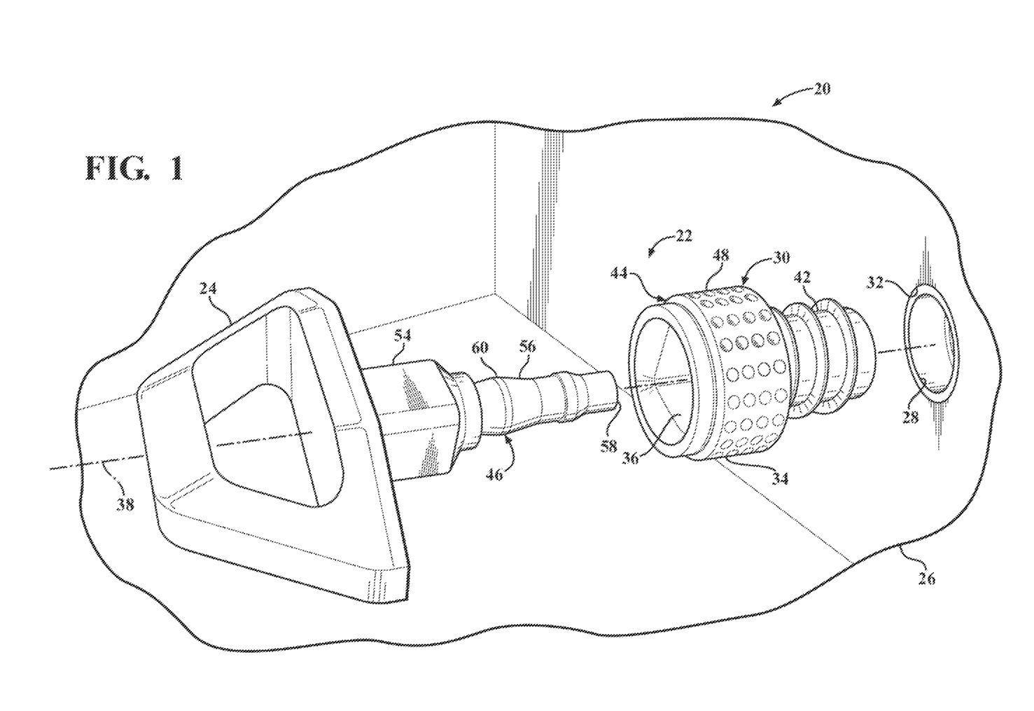

As best shown in FIG. 1, a body 26 of the vehicle 20 defines a threaded aperture 28, into which a female connector 30 may be installed. The location of the threaded aperture 28 defines the accessory location point. Accordingly, multiple threaded apertures 28 may be provided throughout the vehicle 20 to define multiple accessory location points. The threaded aperture 28 may be formed in any suitable manner, including but not limited to attaching a threaded insert 32 to the body 26 of the vehicle 20.

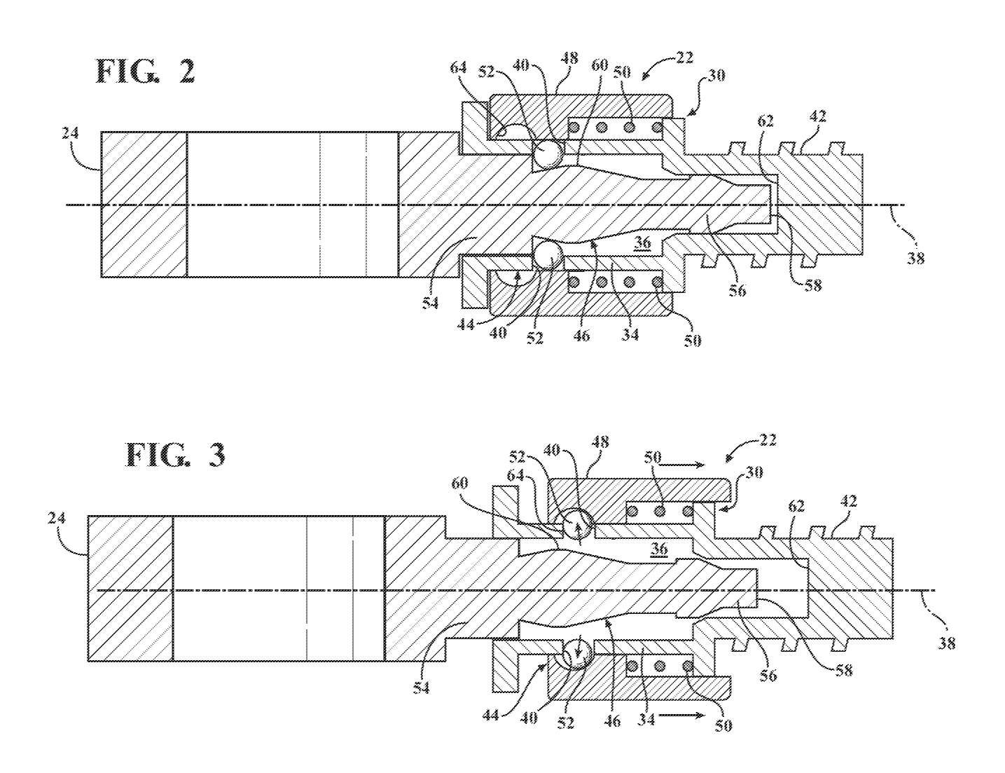

Referring to FIGS. 2 and 3, in order to attach the accessory 24 to the vehicle 20, the female connector 30 is inserted into the threaded aperture 28 in threaded engagement therewith. The female connector 30 includes a tubular portion 34 that defines a central opening 36. The central opening 36 extends along a longitudinal axis 38. The tubular portion 34 defines a plurality of bores 40 that extend radially through the tubular portion 34 and into the central opening 36. The bores 40 are disposed radially about the longitudinal axis 38. The female connector 30 includes a threaded portion 42 that extends from the tubular portion 34. The threaded portion 42 defines threads for engaging the threaded aperture 28 of the body 26 in threaded engagement. As shown in FIGS. 2 and 3, the threaded portion 42 of the female connector 30 may define a solid cross sectional area, i.e., the threaded portion 42 is solid with no passage extending through the length thereof. However, it should be appreciated that a passage may pass through the length of the threaded portion 42 along the longitudinal axis 38.

The female connector 30 includes a locking mechanism 44. The locking mechanism 44 may include any suitable quick connect mechanism capable of quickly and easily securing a male connector portion 46 disposed on the accessory 24 to the female connector 30. The locking mechanism 44 is moveable between a locking position, shown in FIG. 2, and a release position, shown in FIG. 3. As shown, the locking mechanism 44 includes a sleeve 48 that is disposed annularly about an outer periphery of the tubular portion 34. The sleeve 48 is moveable fore and aft along the longitudinal axis 38 relative to the tubular portion 34 in order to move between the locking position and the release position. A biasing device 50 is disposed between the sleeve 48 and the tubular portion 34. The biasing device 50 biases the sleeve 48 axially along the longitudinal axis 38 into the locking position. The sleeve 48 is moved against and compresses the biasing device 50 when in the release position. Accordingly, the sleeve 48 must be manually moved into the release position to compress the sleeve 48, with the biasing device 50 biasing the sleeve 48 back into the locking position once the sleeve 48 is released. The locking mechanism 44 further includes a plurality of locking balls 52. One of the locking balls 52 is disposed within each of the plurality of bores 40. The operation of the locking mechanism 44 is described in greater detail below.

As noted above, the accessory 24 includes the male connector portion 46 fixedly attached thereto. The male connector portion 46 may be integrally formed with the accessory 24, or alternatively, the male connector portion 46 may be a separate component from the accessory 24, and securely affixed to the accessory 24. The male connector portion 46 is slideably insertable into the central opening 36 of the female connector 30. The male connector portion 46 includes a base 54, which is adjacent and attached to the accessory 24. The male connector portion 46 further includes a shaft 56, which extends outward away from the base 54 to a distal end 58. The shaft 56 defines a ridge 60 that extends radially outward from the shaft 56. As shown in FIGS. 2 and 3, the shaft 56 of the male connector portion 46 defines a solid cross sectional area, i.e., the shaft 56 is solid with no passage extending through a length thereof. However, it should be appreciated that a passage may pass through the length of the shaft 56.

The locking mechanism 44 axially secures the male connector portion 46 to prevent movement along the longitudinal axis 38 when in the locking position, and releases the male connector portion 46 to allow axial movement along the longitudinal axis 38 when in the release position. More specifically, in order to install the accessory 24 to the vehicle 20, the ridge 60 on the male connector portion 46 is inserted into the central opening 36 axially along the longitudinal axis 38, until the ridge 60 is disposed beyond the plurality of locking balls 52, such that the ridge 60 is disposed between the plurality of locking balls 52 and a bottom wall 62 of the central opening 36. When fully inserted into the female connector 30 with the sleeve 48 in the locking position, the locking balls 52 are restrained from radial movement outward away from the shaft 56 of the male connector portion 46 by the sleeve 48, thereby blocking withdrawal of the ridge 60 and axially securing the male connector portion 46 relative to the female connector 30 along the longitudinal axis 38. Movement of the sleeve 48 from the locking position into the release position allows the locking balls 52 to move radially outward away from the longitudinal axis 38, into an annular groove 64 and out of interlocking engagement with the male connector portion 46 of the accessory 24, thereby allowing the ridge 60 to move out of the central opening 36 past the locking balls 52. Movement of the sleeve 48 from the release position into the locking position moves the locking balls 52 radially inward toward the longitudinal axis 38 into interlocking engagement with the male connector portion 46 of the accessory 24.

Preferably, the central opening 36 defines a non-circular cross sectional shape perpendicular to the longitudinal axis 38, and the base 54 defines a shape complimentary to the non-circular cross sectional shape of the central opening 36. The complimentary non-circular shape of the base 54 mates with the non-circular cross sectional shape of the central opening 36 such that the base 54 is rotationally fixed relative to the female connector 30 when disposed within the central opening 36. As shown, the non-circular cross sectional shape of the central opening 36 includes a square cross sectional shape, and the non-circular cross sectional shape of the base 54 also includes a square cross sectional shape. The square cross sectional shape of the base 54 is sized to fit within the square cross sectional shape of the central opening 36 without rotating relative to the female connector 30. While the non-circular cross sectional shape of the base 54 and the central opening 36 is described and shown herein as including a square shape, it should be appreciated that the non-circular cross sectional shape of the base 54 and the central opening 36 may include any shape that prevents relative rotation about the longitudinal axis 38, including but not limited to any polygon shape, an elliptical shape or a star pattern. Furthermore, it should be appreciated that the cross sectional shape of the base 54 and the central opening 36 may include a circular shape to allow the male connector portion 46 and the accessory 24 to rotate relative to the female connector 30 about the longitudinal axis 38.

While the best modes for carrying out the invention have been described in detail, those familiar with the art to which this invention relates will recognize various alternative designs and embodiments for practicing the invention within the scope of the appended claims.

1. A vehicle comprising:
a body defining a threaded aperture;
a female connector in threaded engagement with the threaded aperture and defining a central opening extending along a longitudinal axis, and including a locking mechanism moveable between a locking position and a release position; and
an accessory having a male connector portion slideably insertable into the central opening of the female connector, wherein the locking mechanism axially secures the male connector portion to prevent movement along the longitudinal axis when in the locking position, and releases the male connector portion to allow axial movement along the longitudinal axis when in the release position;
wherein the central opening defines a non-circular cross sectional shape perpendicular to the longitudinal axis, and
wherein the male connector portion includes a base defining a shape complimentary to the non-circular cross sectional shape of the central opening for mating with the central opening such that the base is rotationally fixed relative to the female connector when disposed within the central opening.

2. A vehicle as set forth in claim 1 wherein the female connector includes a tubular portion that defines the central opening and a plurality of bores extending radially through the tubular portion into the central opening and disposed radially about the longitudinal axis.

3. A vehicle as set forth in claim 2 wherein the female connector includes a threaded portion extending from the tubular portion and defining threads for engaging the threaded aperture of the body in threaded engagement.

4. A vehicle as set forth in claim 3 wherein the locking mechanism includes a sleeve disposed annularly about an outer periphery of the tubular portion and moveable relative to the tubular portion along the longitudinal axis between the locking position and the release position.

5. A vehicle as set forth in claim 4 wherein the locking mechanism includes a biasing device disposed between the sleeve and the tubular portion, and biasing the sleeve axially along the longitudinal axis into the locking position, wherein the sleeve compresses the biasing device when in the release position.

6. A vehicle as set forth in claim 5 wherein the locking mechanism includes a plurality of locking balls, with one of the plurality of locking balls disposed within each of the plurality of bores, wherein movement of the sleeve from the locking position into the release position allows the locking balls to move radially outward away from the longitudinal axis out of interlocking engagement with the male connector portion of the accessory, and wherein movement of the sleeve from the release position into the locking position moves the locking balls radially inward toward the longitudinal axis into interlocking engagement with the male connector portion of the accessory.

7. A vehicle as set forth in claim 6 wherein the male connector portion includes a shaft extending outward away from the base to a distal end, with the shaft defining a ridge that extends radially outward from the shaft.

8. A vehicle as set forth in claim 7 wherein the shaft of the male connector portion defines a solid cross sectional area.

9. A vehicle as set forth in claim 7 wherein the ridge is insertable into the central opening axially beyond the plurality of locking balls such that the ridge is disposed between the plurality of locking balls and a bottom wall of the central opening when fully inserted into the female connector, with the locking balls restrained from radial movement outward away from the shaft of the male connector portion by the sleeve when the sleeve is in the locking position to secure the male connector portion relative to the female connector.

10. A vehicle as set forth in claim 1 wherein the non-circular cross sectional shape of the central opening includes a square cross sectional shape, and wherein the base of the male connector portion includes a square cross sectional shape sized to fit within the square cross sectional shape of the central opening without rotating relative to the female connector.

11. An accessory connection system for a vehicle, the accessory connection system comprising:
a female connector configured for threaded engagement with a threaded aperture in a vehicle, wherein the female connector defines a central opening extending along a longitudinal axis, and includes a locking mechanism moveable between a locking position and a release position; and
a male connector portion configured for attachment to an accessory, wherein the male connector portion is slideably insertable into the central opening of the female connector;
wherein the locking mechanism axially secures the male connector portion to prevent movement along the longitudinal axis when in the locking position, and releases the male connector portion to allow axial movement along the longitudinal axis when in the release position.

12. An accessory connection system as set forth in claim 11 wherein the central opening defines a non-circular cross sectional shape perpendicular to the longitudinal axis, and wherein the male connector portion includes a base defining a shape complimentary to the non-circular cross sectional shape of the central opening for mating with the central opening such that the base is rotationally fixed relative to the female connector when disposed within the central opening.

13. An accessory connection system as set forth in claim 12 wherein the non-circular cross sectional shape of the central opening includes a square cross sectional shape, and wherein the base of the male connector portion includes a square cross sectional shape sized to fit within the square cross sectional shape of the central opening without rotating relative to the female connector.

14. An accessory connection system as set forth in claim 11 wherein the female connector includes a tubular portion that defines the central opening, a plurality of bores extending radially through the tubular portion into the central opening and disposed radially about the longitudinal axis, and a threaded portion extending from the tubular portion and defining threads.

15. An accessory connection system as set forth in claim 14 wherein the locking mechanism includes a sleeve disposed annularly about an outer periphery of the tubular portion and moveable relative to the tubular portion along the longitudinal axis between the locking position and the release position.

16. An accessory connection system as set forth in claim 15 wherein the locking mechanism includes a biasing device disposed between the sleeve and the tubular portion to bias the sleeve axially along the longitudinal axis into the locking position, wherein the sleeve compresses the biasing device when in the release position.

17. An accessory connection system as set forth in claim 16 wherein the locking mechanism includes a plurality of locking balls, with one of the plurality of locking balls disposed within each of the plurality of bores, wherein movement of the sleeve from the locking position into the release position allows the locking balls to move radially outward away from the longitudinal axis out of interlocking engagement with the male connector portion, and wherein movement of the sleeve from the release position into the locking position moves the locking balls radially inward toward the longitudinal axis into interlocking engagement with the male connector portion.

18. An accessory connection system as set forth in claim 17 wherein the male connector portion includes a shaft extending outward away from the base to a distal end, with the shaft defining a ridge that extends radially outward from the shaft.

19. An accessory connection system as set forth in claim 18 wherein the ridge is insertable into the central opening along the longitudinal axis beyond the plurality of locking balls such that the ridge is disposed between the plurality of locking balls and a bottom wall of the central opening when fully inserted into the female connector, with the locking balls restrained from radial movement outward away from the shaft of the male connector portion by the sleeve when the sleeve is in the locking position to secure the male connector portion relative to the female connector.

20. An accessory connection system for a vehicle, the accessory connection system comprising:
a female connector configured for threaded engagement with a threaded aperture in a vehicle, wherein the female connector includes a tubular portion that defines a central opening extending along a longitudinal axis, a plurality of bores extending radially through the tubular portion into the central opening and disposed radially about the longitudinal axis, a threaded portion extending from the tubular portion and defining threads, and a locking mechanism moveable between a locking position and a release position;
wherein the locking mechanism includes a sleeve disposed annularly about an outer periphery of the tubular portion and moveable relative to the tubular portion along the longitudinal axis between the locking position and the release position, a biasing device disposed between the sleeve and the tubular portion to bias the sleeve axially along the longitudinal axis into the locking position, with the sleeve compressing the biasing device when in the release position, and a plurality of locking balls, with one of the plurality of locking balls disposed within each of the plurality of bores, wherein movement of the sleeve from the locking position into the release position allows the locking balls to move radially outward away from the longitudinal axis out of interlocking engagement with the male connector portion, and wherein movement of the sleeve from the release position into the locking position moves the locking balls radially inward toward the longitudinal axis into interlocking engagement with the male connector portion; and
a male connector portion configured for attachment to an accessory, wherein the male connector portion includes a base and a shaft extending outward away from the base to a distal end, with the shaft defining a ridge that extends radially outward from the shaft, wherein the shaft is slideably insertable into the central opening of the female connector such that the ridge is disposed axially along the longitudinal axis beyond the plurality of locking balls between the plurality of locking balls and a bottom wall of the central opening when fully inserted into the female connector, with the locking balls restrained from radial movement outward away from the shaft of the male connector portion by the sleeve when the sleeve is in the locking position to secure the male connector portion relative to the female connector, and the locking balls allowed to move radially outward away from the shaft of the male connector portion when the sleeve is in the release position to allow axial movement of the shaft along the longitudinal axis relative to the female connector;
wherein the central opening defines a non-circular cross sectional shape perpendicular to the longitudinal axis,
wherein the base of the male connector portion defines a shape complimentary to the non-circular cross sectional shape of the central opening for mating with the central opening such that the base is rotationally fixed relative to the female connector when disposed within the central opening; and
wherein both the shaft of the male connector portion and the threaded portion of the female connector define solid cross sectional areas.
